(19) United States
(12) Patent Application Publication
(10) Pub. No.: US 2020/0298812 A1
(43) Pub. Date: Sep. 24, 2020

(54) VEHICLE BRAKING CONTROL APPARATUS

(71) Applicant: Toyota Jidosha Kabushiki Kaisha, Toyota-shi Aichi-ken (JP)

(72) Inventors: Kosuke Futagami, Mishima-shi (JP); Yuji Yoshii, Mishima-shi (JP)

(73) Assignee: Toyota Jidosha Kabushiki Kaisha, Toyota-shi Aichi-ken (JP)

(21) Appl. No.: 16/825,146

(22) Filed: Mar. 20, 2020

(30) Foreign Application Priority Data
Mar. 22, 2019 (JP) 2019-054821

(51) Int. Cl. B60T 13/66; B60T 7/12; B60T 8/171

(52) U.S. Cl. CPC B60T 13/662; B60T 8/171; B60T 7/12

(57) ABSTRACT

A vehicle braking control apparatus starts to execute a hydraulically moving process to move a hydraulically-moved member toward a brake disc when an emergency braking control is requested to be executed to move the hydraulically-moved member and a mechanically-moved member toward the brake disc to apply braking force to a wheel of a vehicle. The vehicle braking control apparatus starts to execute a mechanically moving process to move the mechanically-moved member toward the brake disc when a predetermined time elapses since starting to execute the hydraulically moving process. The vehicle braking control apparatus stops executing the hydraulically moving process and the mechanically moving process and executes a hydraulically releasing process to move the hydraulically-moved member away from the brake disc and a mechanically releasing process to move the mechanically-moved member away from the brake disc when an execution of the emergency braking control is requested to be stopped.

### CROSS-REFERENCE TO RELATED APPLICATIONS

This application claims priority to Japanese Patent Application No. JP 2019-054821 filed on Mar. 22, 2019, the content of which is hereby incorporated by reference in its entirety into this application.

### BACKGROUND

### Field

The present disclosure relates to a vehicle braking control apparatus.

### Description of the related art

JP 2009-166656 A describes a vehicle provided with a vehicle braking control apparatus for controlling an activation of a friction brake apparatus configured to press brake pads to respective brake discs by hydraulic pressure or respective electric motors to apply braking forces to respective wheels of the vehicle. The friction brake apparatus described in JP 2009-166656 A is configured to apply the braking forces to the respective left and right front and rear wheels by the hydraulic pressure and apply the braking forces to the respective left and right rear wheels by the respective electric motors.

The vehicle described in JP 2009-166656 A is provided with a parking brake switch used for requesting the braking apparatus to apply the braking forces to the respective wheels of the vehicle by pressing the brake pads to the respective brake discs by the respective electric motors when the vehicle has stopped. JP 2009-166656 A also describes a control to brake the vehicle by pressing the brake pads to the respective brake discs by the hydraulic pressure and the respective electric motors to apply the braking forces to the respective wheels of the vehicle when the parking brake switch is operated while the vehicle is moving. Hereinafter, the parking brake switch will be referred to as “the EPB switch”.

There is known a friction brake apparatus including (i) members moved by the hydraulic pressure toward and away from the respective brake discs and (ii) members moved by the respective electric motors toward and away from the respective brake discs. Hereinafter, the member moved by the hydraulic pressure toward and away from the respective brake disc will be referred to as “the hydraulically-moved member”, and the member moved by the respective electric motor toward and away from the respective brake disc will be referred to as “the mechanically-moved member”.

The hydraulically-moved members can apply the braking forces to the respective wheels of the vehicle when the hydraulically-moved members are moved to move the respective brake pads toward the respective brake discs to press the respective brake pads to the respective brake discs. Similarly, the mechanically-moved members can apply the braking forces to the respective wheels of the vehicle when the mechanically-moved members are moved to move the respective brake pads toward the respective brake discs to press the respective brake pads to the respective brake discs.

A driver of the vehicle may return the EPB switch to an OFF position immediately after the driver mistakenly positions the EPB switch at an ON position when the vehicle is moving. The vehicle braking control apparatus may be configured to start to move the hydraulically-moved members and the mechanically-moved members toward the respective brake discs at a point of time when the EPB switch is positioned at the ON position. In this case, the mechanically-moved members may have been moved for relatively long distances, respectively at a point of time when the EPB switch is returned to the OFF position.

The vehicle braking control apparatus may be configured to decrease the hydraulic pressure applied to the respective hydraulically-moved members to zero at once at the point of time when the EPB switch is positioned at the OFF position. In this case, distances that the mechanically-moved members have moved do not become zero, respectively when distances that the hydraulically-moved members have moved become zero, respectively. Therefore, the braking forces may be applied to the respective wheels of the vehicle by the respective mechanically-moved members when the distances that the hydraulically-moved members have moved become zero, respectively. In this case, the vehicle does not move with stability.

### SUMMARY

An object of the present disclosure is to provide a vehicle braking control apparatus for applying a braking force to the wheel of the vehicle by the brake apparatus configured to move the hydraulically-moved member and the mechanically-moved member toward the brake disc and which can brake the vehicle without causing unstable movement of the vehicle due to the braking force applied to the wheel of the vehicle by the mechanically-moved member.

A vehicle braking control apparatus according to the present disclosure is applied to a vehicle. The vehicle braking control apparatus according to the present disclosure comprises at least one brake apparatus and an electronic control unit. The at least one brake apparatus includes at least one brake pad, at least one brake disc, at least one hydraulically-moved member, and at least mechanically-moved member. The at least one hydraulically-moved member is configured to be moved by hydraulic pressure in a direction toward the at least one brake disc and in a direction away from the at least one brake disc. The at least mechanically-moved member is configured to be moved by an electric motor in the direction toward the at least one brake disc and in the direction away from the at least one brake disc. The electronic control unit is configured to control an activation of the at least one brake apparatus.

The at least one brake pad is configured to be moved toward the at least one brake disc to be pressed to the at least one brake disc to apply a braking force to at least one wheel of the vehicle by moving the at least one hydraulically-moved member toward the at least one brake disc.

The at least one brake pad is configured to be moved toward the at least one brake disc to be pressed to the at least one brake disc to apply the braking force to the at least one wheel of the vehicle by moving the at least one mechanically-moved member toward the at least one brake disc.

The electronic control unit is configured to start an execution of a hydraulically moving process to move the at least one hydraulically-moved member toward the at least one brake disc when an emergency braking control is requested to be executed to move the at least one hydraulically-moved member and the at least one mechanically-moved member toward the at least one brake disc to apply the braking force to the at least one wheel of the vehicle. Then, the electronic control unit is configured to start an execution of a mechanically moving process to move the at least one mechanically-moved member toward the at least one brake disc when a predetermined time elapses since the electronic control unit starts the execution of the hydraulically moving process.

The electronic control unit is configured to stop the execution of the hydraulically moving process and the execution of the mechanically moving process and execute (i) a hydraulically releasing process to move the at least one hydraulically-moved member away from the at least one brake disc and (ii) a mechanically releasing process to move the at least one mechanically-moved member away from the at least one brake disc when an execution of the emergency braking control is requested to be stopped.

With the present disclosure, the mechanically moving process does not start to be executed until the predetermined time elapses since the emergency braking control is requested to be executed. Therefore, the mechanically-moved member may not be moved toward the brake disc when an execution of the emergency braking control is requested to be stopped immediately after the emergency braking control is requested to be executed when the vehicle is moving. Alternatively, a distance that the mechanically-moved member has been moved may be small even when the mechanically-moved member has been moved toward the brake disc at the point of time when the execution of the emergency braking control is requested to be stopped.

The vehicle may move with stability even by decreasing the hydraulic pressure applied to the hydraulically-moved member to zero at once to decrease the braking force applied to the wheel of the vehicle to zero when the mechanically-moved member is not moved toward the brake disc. Alternatively, the distance that the mechanically-moved member has been moved is decreased to zero for a short time when the distance that the mechanically-moved member has been moved is short. With the emergency braking control according to the present disclosure, the braking force applied to the wheel of the vehicle can be decreased to zero for a short time after the execution of the emergency braking control is requested to be stopped.

According to an aspect of the present disclosure, the electronic control unit may be configured to execute the hydraulically releasing process and the mechanically releasing process such that a hydraulic braking force is maintained greater than or equal to a mechanical braking force. The hydraulic braking force is the braking force applied to the at least one wheel of the vehicle by pressing the at least one brake pad to the at least one brake disc by the at least one hydraulically-moved member. The mechanical braking force is the braking force applied to the at least one wheel of the vehicle by pressing the at least one brake pad to the at least one brake disc by the at least one mechanically-moved member.

With this aspect of the present disclosure, the braking force applied to the wheel of the vehicle by pressing the brake pad to the brake disc by the hydraulically-moved member may be maintained greater than or equal to the braking force applied to the vehicle wheel by pressing the brake pad to the brake disc by the mechanically-moved member. Therefore, the vehicle may move with stability.

A vehicle braking control apparatus according to another present disclosure is also applied to a vehicle. The vehicle braking control apparatus according to this present disclosure also comprises at least one brake apparatus and an electronic control unit. The at least one brake apparatus also includes at least one brake pad, at least one brake disc, at least one hydraulically-moved member, and at least mechanically-moved member. The at least one hydraulically-moved member is also configured to be moved by hydraulic pressure in a direction toward the at least one brake disc and in a direction away from the at least one brake disc. The at least mechanically-moved member is also configured to be moved by an electric motor in the direction toward the at least one brake disc and in the direction away from the at least one brake disc. The electronic control unit is also configured to control an activation of the at least one brake apparatus.

The at least one brake pad is also configured to be moved toward the at least one brake disc to be pressed to the at least one brake disc to apply a braking force to at least one wheel of the vehicle by moving the at least one hydraulically-moved member toward the at least one brake disc.

The at least one brake pad is also configured to be moved toward the at least one brake disc to be pressed to the at least one brake disc to apply the braking force to the at least one wheel of the vehicle by moving the at least one mechanically-moved member toward the at least one brake disc.

According to this present disclosure, the electronic control unit is configured to execute a hydraulically moving process and a mechanically moving process when an emergency braking control is requested to be executed to move the at least one hydraulically-moved member and the at least one mechanically-moved member toward the at least one brake disc to apply the braking force to the at least one wheel of the vehicle. The hydraulically moving process is also a process to move the at least one hydraulically-moved member toward the at least one brake disc. The mechanically moving process is also a process to move the at least one mechanically-moved member toward the at least one brake disc.

According to this present disclosure, the electronic control unit is further configured to stop an execution of the hydraulically moving process and an execution of the mechanically moving process and execute (i) a hydraulically releasing process to move the at least one hydraulically-moved member away from the at least one brake disc and (ii) a mechanically releasing process to move the at least one mechanically-moved member away from the at least one brake disc such that a hydraulic braking force is maintained greater or equal to a mechanical braking force. The hydraulic braking force is also the braking force applied to the at least one wheel of the vehicle by pressing the at least one brake pad to the at least one brake disc by the at least one hydraulically-moved member. The mechanical braking force is also the braking force applied to the at least one wheel of the vehicle by pressing the at least one brake pad to the at least one brake disc by the at least one mechanically-moved member.

According to another aspect of the present disclosure, the at least one wheel of the vehicle may include at least two wheels. In this case, the at least one hydraulically-moved member may include the same number of hydraulically-moved members as the number of the at least two wheels. In this case, the at least one mechanically-moved member may include the number of mechanically-moved members smaller than the number of the at least two wheels. In this case, the hydraulically-moved members may be provided to the at least two wheels, respectively. In this case, the mechanically-moved members may be provided to a part of the at least two wheels, respectively.

According to further another aspect of the present disclosure, the at least one hydraulically-moved member may be configured to apply a hydraulic braking force greater than a maximum mechanical braking force to the at least one wheel of the vehicle. In this case, the hydraulic braking force is generated by pressing the at least one brake pad to the at least one brake disc by the at least one hydraulically-moved member. The maximum mechanical braking force is maximumly generated by pressing the at least one brake pad to the at least one brake disc by the at least one mechanically-moved member.

The elements of the present disclosure are not limited to elements of embodiments of the present disclosure. The other objects, features and accompanied advantages of the present disclosure can be easily understood from the description of the embodiment of the present disclosure along with the drawings.

### BRIEF DESCRIPTION OF THE DRAWINGS

FIG. 1 is a view for showing a vehicle control apparatus including a vehicle braking control apparatus according to an embodiment of the present disclosure and a vehicle to which the vehicle control apparatus is applied.

FIG. 2 is a view for showing the vehicle and brake apparatuses shown in FIG. 1.

FIG. 3A is a view for showing the brake apparatus provided to a left front wheel of the vehicle shown in FIG. 2.

FIG. 3B is a view for showing the brake apparatus provided to a right front wheel of the vehicle shown in FIG. 2.

FIG. 3C is a view for showing the brake apparatus provided to a left rear wheel of the vehicle shown in FIG. 2.

FIG. 3D is a view for showing the brake apparatus provided to a right rear wheel of the vehicle shown in FIG. 2.

FIG. 4A is a view for showing a state that a front wheel brake pad is pressed to a front wheel brake disc by a front wheel hydraulically-moved member.

FIG. 4B is a view for showing a state that a rear wheel brake pad is pressed to a rear wheel brake disc by a rear wheel hydraulically-moved member.

FIG. 4C is a view for showing a state that the rear wheel brake pad is pressed to the rear wheel brake disc by a mechanically-moved member.

FIG. 5 is a view for showing a time chart showing changes of a braking force applied to the rear wheel of the vehicle, etc. when a parking brake control and a parking brake releasing control are executed.

FIG. 6 is a view for showing a time chart showing changes of the braking force applied to the rear wheel of the vehicle, etc. when an emergency braking control is executed.

FIG. 7 is a view for showing a time chart showing changes of the braking force applied to the rear wheel of the vehicle, etc. when an emergency braking releasing control is executed.

FIG. 8 is a view for showing a time chart showing changes of the braking force applied to the rear wheel of the vehicle, etc. when a driver of the vehicle requests an execution of the emergency braking control mistakenly.

FIG. 9 is a view for showing a time chart showing changes of the braking force applied to the rear wheel of the vehicle, etc. when the driver of the vehicle requests the execution of the emergency braking control mistakenly.

FIG. 10 is a view for showing a time chart showing changes of the braking force applied to the rear wheel of the vehicle, etc. when the driver of the vehicle requests the execution of the emergency braking control mistakenly.

FIG. 11 is a view for showing a flowchart of a routine executed by a CPU of an ECU shown in FIG. 1.

FIG. 12 is a view for showing a flowchart of a routine executed by the CPU.

FIG. 13 is a view for showing a flowchart of a routine executed by the CPU.

### DESCRIPTION OF THE EMBODIMENTS

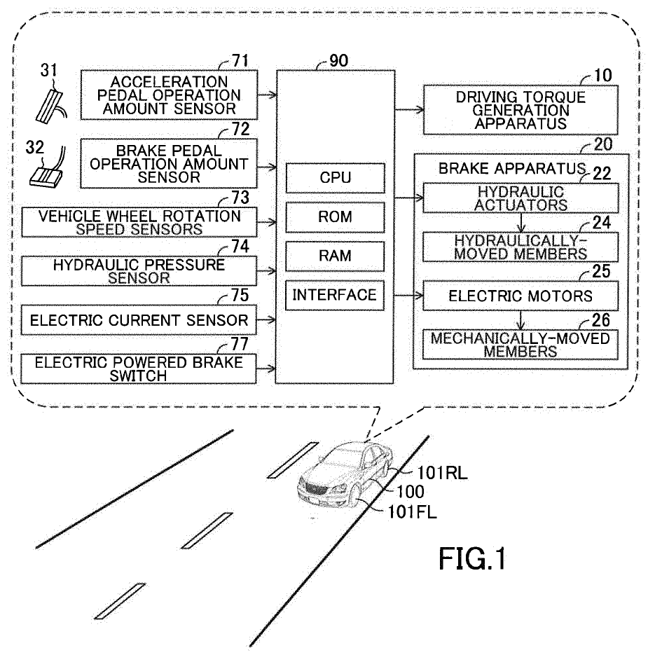

Below, a vehicle control apparatus including a vehicle braking control apparatus according to an embodiment of the present disclosure will be described with reference to the drawings. Hereinafter, the vehicle control apparatus including the vehicle braking control apparatus according to the embodiment of the present disclosure will be referred to as “the embodiment control apparatus”. The embodiment control apparatus is applied to a vehicle 100 shown in FIG. 1. The embodiment control apparatus includes an ECU 90. The ECU stands for an electronic control unit. The ECU 90 includes a microcomputer as a main component. The microcomputer includes a CPU, a ROM, a RAM, a non-volatile memory, and an interface. The CPU realizes various functions by executing instructions, programs, or routines stored in the ROM.

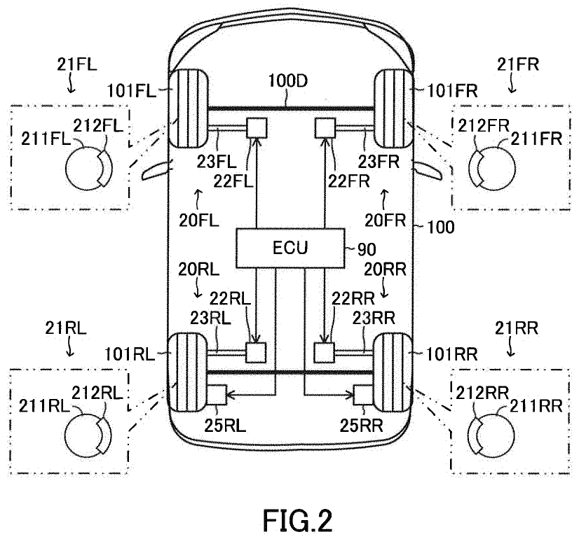

As shown in FIG. 2, the vehicle 100 includes a left front wheel 101FL, a right front wheel 101FR, a left rear wheel 101RL, and a right rear wheel 101RR. Below, the left front wheel 101FL and the right front wheel 101FR will be collectively referred to as “the front wheels 101F”, the left rear wheel 101RL and the right rear wheel 101RR will be collectively referred to as “the rear wheels 101R”, and the left front wheel 101FL, the right front wheel 101FR, the left rear wheel 101RL, and the right rear wheel 101RR will be collectively referred to as “the wheels 101”.

### Driving Torque Generation Apparatus

As shown in FIG. 1, the vehicle 100 is provided with a driving torque generation apparatus 10. The driving torque generation apparatus 10 includes an internal combustion engine (not shown) and at least one motor generator (not shown). A torque output from the internal combustion engine is transmitted to the left front wheel 101FL and the right front wheel 101FR via a drive shaft 100D, etc. A torque output from the motor generator is also transmitted to the left front wheel 101FL and the right front wheel 101FR via the drive shaft 100D, etc. The vehicle 100 is driven by the torques.

The vehicle 100 to which the embodiment control apparatus is applied is a so-called hybrid vehicle. The vehicle 100 may be a vehicle provided with the internal combustion engine only as the driving torque generation apparatus. Alternatively, the vehicle 100 may be a so-called plug-in hybrid vehicle provided with the internal combustion engine and the at least one motor generator as the driving torque generation apparatus and provided with a battery which can be charged electrically by an outside electric power source. Alternatively, the vehicle 100 may be a so-called electric vehicle provided with the at least one motor generator only as the driving torque generation apparatus. Alternatively, the vehicle 100 may be a so-called fuel cell vehicle provided with the motor generator as the driving force generation apparatus and using an electric power generated by fuel cells to activate the motor generator.

### Brake Apparatus

As shown in FIG. 1, the vehicle 100 is provided with a brake apparatus 20. As shown in FIG. 2, the brake apparatus 20 includes a left front wheel brake apparatus 20FL, a right front wheel brake apparatus 20FR, a left rear wheel brake apparatus 20RL, and a right rear wheel brake apparatus 20RR.

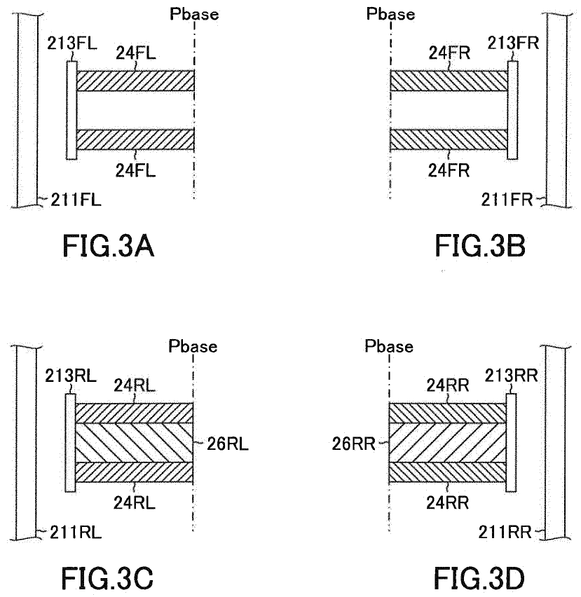

As shown in FIG. 2 and FIG. 3A, the left front wheel brake apparatus 20FL includes a left front wheel friction brake mechanism 21FL, a left front wheel hydraulic actuator 22FL, a left front wheel hydraulic oil passage 23FL, and a left front wheel hydraulically-moved member 24FL The left front wheel friction brake mechanism 21FL includes a left front wheel brake disc 211FL and a left front wheel brake caliper 212FL. The left front wheel brake disc 211FL is secured to the left front wheel 101FL. The left front wheel brake caliper 212FL is secured to a body of the vehicle 100. The left front wheel brake caliper 212FL includes a left front wheel brake pad 213FL.

As shown in FIG. 2 and FIG. 3B, the right front wheel brake apparatus 20FR includes a right front wheel friction brake mechanism 21FR, a right front wheel hydraulic actuator 22FR, a right front wheel hydraulic oil passage 23FR, and a right front wheel hydraulically-moved member 24FR. The right front wheel friction brake mechanism 21FR includes a right front wheel brake disc 211FR and a right front wheel brake caliper 212FR. The right front wheel brake disc 211FR is secured to the right front wheel 101FR. The right front wheel brake caliper 212FR is secured to the body of the vehicle 100. The right front wheel brake caliper 212FR includes a right front wheel brake pad 213FR.

As shown in FIG. 2 and FIG. 3C, the left rear wheel brake apparatus 2ORL includes a left rear wheel friction brake mechanism 21RL, a left rear wheel hydraulic actuator 22RL, a left rear wheel hydraulic oil passage 23RL, a left rear wheel hydraulically-moved member 24RL, a left rear wheel electric motor 25RL, and a left rear wheel mechanically-moved member 26RL. The left rear wheel friction brake mechanism 21RL includes a left rear wheel brake disc 211RL and a left rear wheel brake caliper 212RL The left rear wheel brake disc 211RL is secured to the left rear wheel 101RL. The left rear wheel brake caliper 212RL is secured to the body of the vehicle 100. The left rear wheel brake caliper 212RL includes a left rear wheel brake pad 213RL.

As shown in FIG. 2 and FIG. 3D, the right rear wheel brake apparatus 20RR includes a right rear wheel friction brake mechanism 21RR, a right rear wheel hydraulic actuator 22RR, a right rear wheel hydraulic oil passage 23RR, a right rear wheel hydraulically-moved member 24RR, a right rear wheel electric motor 25RR, and a right rear wheel mechanically-moved member 26RR. The right rear wheel friction brake mechanism 21RR includes a right rear wheel brake disc 211RR and a right rear wheel brake caliper 212RR. The right rear wheel brake disc 211RR is secured to the right rear wheel 101RR. The right rear wheel brake caliper 212RR is secured to the body of the vehicle 100. The right rear wheel brake caliper 212RR includes a right rear wheel brake pad 213RR.

Below, the left front wheel hydraulic actuator 22FL and the right front wheel hydraulic actuator 22FR will be collectively referred to as “the front wheel hydraulic actuators 22F”, the left rear wheel hydraulic actuator 22RL and the right rear wheel hydraulic actuator 22RR will be collectively referred to as “the rear wheel hydraulic actuators 22R”, and the left front wheel hydraulic actuator 22FL, the right front wheel hydraulic actuator 22FR, the left rear wheel hydraulic actuator 22RL and the right rear wheel hydraulic actuator 22RR will be collectively referred to as “the hydraulic actuators 22”. Further, the left front wheel hydraulically-moved member 24FL and the right front wheel hydraulically-moved member 24FR will be collectively referred to as “the front wheel hydraulically-moved members 24F”, the left rear wheel hydraulically-moved member 24RL and the right rear wheel hydraulically-moved member 24RR will be collectively referred to as “the rear wheel hydraulically-moved members 24R”, and the left front wheel hydraulically-moved member 24FL, the right front wheel hydraulically-moved member 24FR, the left rear wheel hydraulically-moved member 24RL, and the right rear wheel hydraulically-moved member 24RR will be collectively referred to as “the hydraulically-moved members 24”.

Further, below, the left front wheel hydraulic oil passage 23FL and the right front wheel hydraulic oil passage 23FR will be collectively referred to as “the front wheel hydraulic oil passages 23F”, the left rear wheel hydraulic oil passage 23RL and the right rear wheel hydraulic oil passage 23RR will be collectively referred to as “the rear wheel hydraulic oil passages 23R”, and the left front wheel hydraulic oil passage 23FL, the right front wheel hydraulic oil passage 23FR, the left rear wheel hydraulic oil passage 23RL, and the right rear wheel hydraulic oil passage 23RR will be collectively referred to as “the hydraulic oil passages 23”. Furthermore, the left rear wheel electric motor 25RL and the right rear wheel electric motor 25RR will be collectively referred to as “the electric motors 25”, and the left rear wheel mechanically-moved member 26RL and the right rear wheel mechanically-moved member 26RR will be collectively referred to as “the mechanically-moved members 26”.

Further, below, the left front wheel brake pads 213FL and the right front wheel brake pad 213FR will be collectively referred to as “the front wheel brake pads 213F”, the left rear brake pad 213RL and the right rear wheel brake pad 213RR will be collectively referred to as “the rear wheel brake pads 213R”, and the left front wheel brake pad 213FL, the right front wheel brake pad 213FR, the left rear brake pad 213RL, and the right rear wheel brake pad 213RR will be collectively referred to as “the brake pads 213”. Furthermore, below, the left front wheel brake disc 211FL and the right front wheel brake disc 211FR will be collectively referred to as “the front wheel brake discs 211F”, the left rear wheel brake disc 211RL and the right rear wheel brake disc 211RR will be collectively referred to as “the rear wheel brake discs 211R”, and the left front wheel brake disc 211FL, the right front wheel brake disc 211FR, the left rear wheel brake disc 211RL, and the right rear wheel brake disc 211RR will be collectively referred to as “the brake discs 211”.

The hydraulic actuators 22 are fluidically connected to the respective hydraulically-moved members 24 through the respective hydraulic oil passages 23. The hydraulic actuators 22 is configured to supply hydraulic oil compressed by a master cylinder (not shown) to the respective hydraulically-moved members 24.

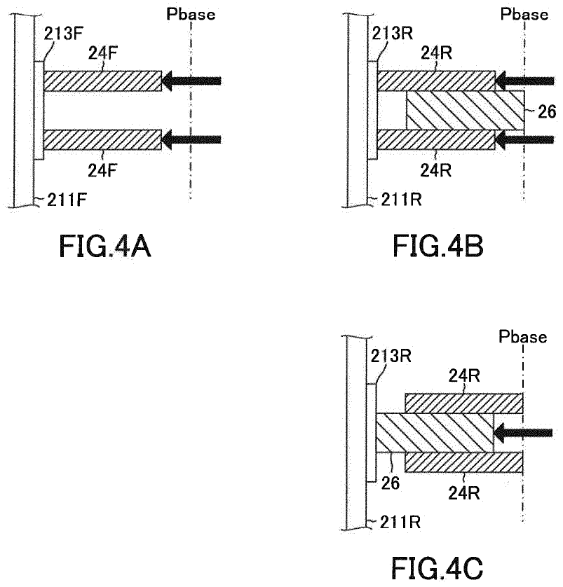

As shown in FIG. 4A, the front wheel hydraulic actuators 22F can move the respective front wheel hydraulically-moved members 24F in respective directions toward the respective front wheel brake discs 211F by applying pressures of the hydraulic oil to the respective front wheel hydraulically-moved members 24F. Hereinafter, the pressure of the hydraulic oil will be referred to as “the hydraulic pressure”, and the direction toward the front wheel brake disc 211F will be referred to as “the braking direction”. The front wheel hydraulically-moved members 24F move the respective front wheel brake pads 213F in the respective braking directions to press the respective front wheel brake pads 213F to the respective front wheel brake discs 211F when the front wheel hydraulically-moved members 24F move in the respective braking directions. Braking forces are applied to the front wheels 101F, respectively when the front wheel brake pads 213F are pressed to the respective front wheel brake discs 211F. Hereinafter, the braking forces applied to the front wheels 101F will be referred to as “the front wheel braking forces Bf”.

Also, the front wheel hydraulically-moved members 24F move in respective directions away from the respective front wheel brake discs 211F when the front wheel hydraulic actuators 22F decrease the hydraulic pressure applied to the respective front wheel hydraulically-moved members 24F. In particular, the front wheel hydraulically-moved members 24F move to respective base positions Pbase when the front wheel hydraulic actuators 22F decrease the hydraulic pressures applied to the respective front wheel hydraulically-moved members 24F to zero, respectively. Hereinafter, the directions away from the front wheel brake discs 211F will be referred to as “the braking release directions”.

As shown in FIG. 4B, the rear wheel hydraulic actuators 22R can move the respective rear wheel hydraulically-moved members 24R in respective directions toward the respective rear wheel brake discs 211R by applying the hydraulic pressure to the respective rear wheel hydraulically-moved members 24R. The directions toward the rear wheel brake discs 211R will be referred to as “the braking directions”.

Also, the rear wheel hydraulically-moved members 24R move in respective directions away from the respective rear wheel brake discs 211R when the rear wheel hydraulic actuators 22R decrease the hydraulic pressure applied to the respective rear wheel hydraulically-moved members 24R. In particular, the rear wheel hydraulically-moved members 24R move to respective base positions Pbase when the rear wheel hydraulic actuators 22R decrease the hydraulic pressure applied to the respective rear wheel hydraulically-moved members 24R to zero, respectively. Hereinafter, the directions away from the rear wheel brake discs 211R will be referred to as “the braking release directions”.

As shown in FIG. 4C, the electric motors 25 move the respective mechanically-moved members 26 in the respective braking directions. In addition, the electric motors 25 move the respective mechanically-moved members 26 in the respective braking release directions.

As shown in FIG. 4B, the rear wheel hydraulically-moved members 24R move the respective rear wheel brake pads 213R in the respective braking directions to press the respective rear wheel brake pads 213R to the respective rear wheel brake discs 211R when (i) the rear wheel hydraulically-moved members 24R are moved in the respective braking directions and (ii) distances that the rear wheel hydraulically-moved members 24R are moved from the respective base positions Pbase are longer than distances that the respective mechanically-moved members 26 are moved from the respective base positions Pbase, respectively. Hereinafter, the distances that the rear wheel hydraulically-moved members 24R are moved from the respective base positions Pbase will be referred to as “the hydraulically-moved distances DH”, and the distances that the mechanically-moved members 26 are moved from the respective base positions Pbase will be referred to as “the mechanically-moved distances DM”. The braking forces are applied to the rear wheels 101R, respectively when the rear wheel brake pads 213R are pressed to the respective rear wheel brake discs 211R. Hereinafter, the braking forces applied to the rear wheels 101R will be referred to as “the rear wheel braking forces Br”.

As shown in FIG. 4C, the mechanically-moved members 26 move the respective rear wheel brake pads 213R in the respective braking directions to press the respective rear wheel brake pads 213R to the respective rear wheel brake discs 211R when (i) the mechanically-moved members 26 are moved in the respective braking directions and (ii) the mechanically-moved distances DM (i.e., the distances that the mechanically-moved members 26 are moved from the respective base positions Pbase) are longer than the respective hydraulically-moved distances DH (i.e., the distances that the rear wheel hydraulically-moved members 24R are moved from the respective base positions Pbase). The braking forces are applied to the rear wheels 101R, respectively when the rear wheel brake pads 213R are pressed to the respective rear wheel brake discs 211R.

The hydraulic actuators 22 are electrically connected to the ECU 90. The ECU 90 controls the hydraulic pressure applied to the hydraulically-moved members 24, respectively to control positions of the hydraulically-moved members 24, i.e., the hydraulically-moved distances DH, respectively.

The electric motors 25 are electrically connected to the ECU 90. The ECU 90 controls activations of the electric motors 25, respectively to control positions of the mechanically-moved members 26, i.e., the mechanically-moved distances DM, respectively.

### Other Elements

As shown in FIG. 1, the vehicle 100 is provided with an acceleration pedal 31, a brake pedal 32, an acceleration pedal operation amount sensor 71, a brake pedal operation amount sensor 72, vehicle wheel rotation speed sensors 73, a hydraulic pressure sensor 74, an electric current sensor 75, and an electrically-powered brake switch 77.

The acceleration pedal operation amount sensor 71 is electrically connected to the ECU 90. The acceleration pedal operation amount sensor 71 detects an operation amount of the acceleration pedal 31 operated by a driver of the vehicle 100 and sends a signal representing the detected operation amount to the ECU 90. The ECU 90 acquires the operation amount of the acceleration pedal 31 as an acceleration pedal operation amount AP, based on the signal sent from the acceleration pedal operation amount sensor 71.

The brake pedal operation amount sensor 72 is electrically connected to the ECU 90. The brake pedal operation amount sensor 72 detects an operation amount of the brake pedal 32 operated by the driver of the vehicle 100 and sends a signal representing the detected operation amount to the ECU 90. The ECU 90 acquires the operation amount of the brake pedal 32 as a brake pedal operation amount BP, based on the signal sent from the brake pedal operation amount sensor 72. In addition, the ECU 90 acquires the braking forces to be applied to the wheels 101 by the brake apparatus 20 as target braking forces Btgt, respectively, based on the brake pedal operation amount BR The ECU 90 controls the activations of the hydraulic actuators 22 to apply the braking forces corresponding to the target braking forces Btgt to the wheels 101 by the brake apparatus 20, respectively.

The vehicle wheel rotation speed sensors 73 are electrically connected to the ECU 90. The vehicle wheel rotation speed sensors 73 detect rotation speeds of the respective wheels 101 and sends signals representing the detected rotation speeds, respectively to the ECU 90. The ECU 90 acquires the rotation speeds of the wheels 101 as vehicle wheel rotation speeds V1 to V4, respectively, based on the signals sent from the vehicle wheel rotation speed sensors 73. In addition, the ECU 90 acquires an average Vave of the acquired vehicle wheel rotation speeds V1 to V4 as a movement speed of the vehicle 100 (Vave=(V1+V2+V3+V4)/4). Hereinafter, the movement speed of the vehicle 100 will be referred to as “the movement speed SPD”.

The hydraulic pressure sensor 74 is electrically connected to the ECU 90. The hydraulic pressure sensor 74 detects the pressure of the hydraulic oil supplied to the hydraulically-moved members 24 from the respective hydraulic actuators 22 and sends a signal representing the detected pressure to the ECU 90. The ECU 90 acquires the pressure of the hydraulic oil supplied to the hydraulically-moved members 24 from the respective hydraulic actuators 22 as the hydraulic pressure Ph, based on the signal sent from the hydraulic pressure sensor 74. In addition, the ECU 90 realizes the hydraulically-moved distances DH, based on the acquired hydraulic pressure Ph.

The electric current sensor 75 is electrically connected to the ECU 90. The electric current sensor 75 detects an electric current flowing through the electric motors 25 and sends a signal representing the detected electric current to the ECU 90. The ECU 90 acquires the electric current flowing through the electric motors 25 as the motor current Im, based on the signal sent from the electric current sensor 75. In addition, the ECU 90 realizes the mechanically-moved distances DM, based on the acquired motor current Im.

The electrically powered brake switch 77 is electrically connected to the ECU 90. The electrically powered brake switch 77 is provided to be operated by the driver of the vehicle 100. Hereinafter, the electrically powered brake switch 77 will be referred to as “the EPB switch 77”.

The EPB switch 77 sends a high signal to the ECU 90 when the EPB switch 77 is positioned at an ON position. The ECU 90 is configured to determine that a parking brake control is requested to be executed when (i) the vehicle 100 has stopped, and (ii) the ECU 90 receives the high signal from the EPB switch 77. The parking brake control is a control to move the mechanically-moved members 26 in the respective braking directions to apply the braking forces to the rear wheels 101R, respectively. Hereinafter, the parking brake control will be referred to as “the EPB control”. Also, the ECU 90 is configured to determine that an emergency braking control is requested to be executed when (i) the vehicle 100 is moving, and (ii) the ECU 90 receives the high signal from the EPB switch 77. The emergency braking control is a control to move the hydraulically-moved members 24 in the respective braking directions to apply the braking forces to the wheels 101, respectively and move the mechanically-moved members 26 in the respective braking directions.

The EPB switch 77 sends a low signal to the ECU 90 when the EPB switch 77 is positioned at an OFF position. The ECU 90 is configured to determine that a parking brake release control is requested to be executed when (i) the ECU 90 executes the EPB control, and (ii) the ECU 90 receives the low signal from the EPB switch 77. Hereinafter, the parking brake release control will be referred to as “the EPB release control”. Also, the ECU 90 is configured to determine that an emergency braking release control is requested to be executed when (i) the ECU 90 executes the emergency braking control, and (ii) the ECU 90 receives the low signal from the EPB switch 77.

### Summary of Operation of Embodiment Control Apparatus

Next, a summary of an operation of the embodiment control apparatus will be described.

### EPB Control

The embodiment control apparatus determines that the EPB control is requested to be executed when (i) the embodiment control apparatus has stopped the vehicle 100, and (ii) the embodiment control apparatus receives the high signal from the EPB switch. The embodiment control apparatus executes the EPB control to move the mechanically-moved members 26 in the respective braking directions to press the respective rear wheel brake pads 213R to the respective rear wheel brake discs 211R. Thereby, the braking forces are applied to the rear wheels 101R, respectively. As a result, the vehicle 100 is maintained at a stopped state. The embodiment control apparatus continues executing the EPB control unless the EPB switch 77 is positioned at the OFF position after the embodiment control apparatus starts the execution of the EPB control.

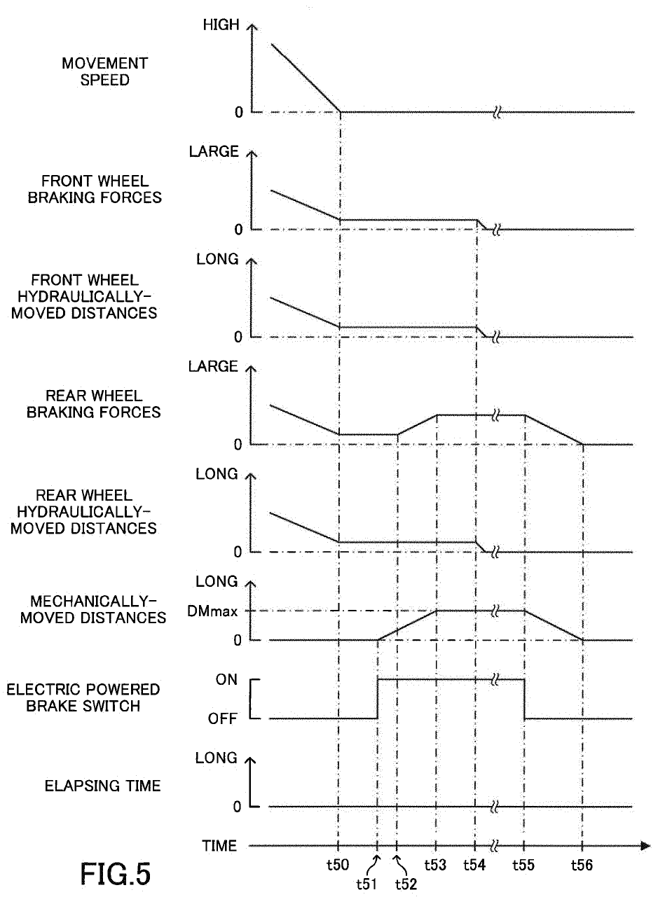

The rear wheel braking force Br, etc. change, for example, as shown in FIG. 5 when the EPB control is executed. FIG. 5 shows changes of the rear wheel braking force Br, etc. when the driver sets the EPB switch 77 at the ON position after the driver operates the brake pedal 32 to decrease the movement speed SPD to zero.

In an example shown in FIG. 5, the movement speed SPD decreases to zero, and the vehicle 100 stops at a point of time t50. The driver gradually decreases the operation amount of the brake pedal 32 as the movement speed SPD decreases. Thus, the hydraulically-moved distances DH decreases gradually. As a result, the braking forces B decrease gradually.

Then, the EPB switch 77 is positioned at the ON position at a point of time t51 when the vehicle 100 has stopped. At this moment, the embodiment control apparatus determines that the EPB control is requested to be executed. Then, the embodiment control apparatus starts the execution of the EPB control. Thereby, the mechanically-moved members 26 are moved in the respective braking directions. As a result, the mechanically-moved distances DM increase. Then, the mechanically-moved distances DM exceed the rear wheel hydraulically-moved distances DHr at a point of time t52. Thereafter, the rear wheel braking forces Br increase. Then, the mechanically-moved distances DM reach a maximum moved distance DMmax at a point of time t53. As a result, the rear wheel braking forces Br reach the braking forces corresponding to the maximum moved distance DMmax. At this moment, the front wheel braking forces Bf reach the braking forces corresponding to the front wheel hydraulically-moved distances DHf.

Then, the driver releases the brake pedal 32 at a point of time t54. Thereby, the embodiment control apparatus stops supplying the hydraulic oil from the hydraulic actuators 22 to the respective hydraulically-moved members 24. Thereby, the hydraulically-moved members 24 move in the respective braking release directions. As a result, the mechanically-moved distances DM decrease to zero, respectively. The mechanically-moved distances DM reach the maximum moved distance DMmax at the point of time t54, respectively. Thus, the rear wheel braking forces Br are maintained at the braking forces corresponding to the maximum moved distance DMmax, respectively even when the driver releases the brake pedal 32.

### EPB Release Control

The embodiment control apparatus determines that the EPB release control is requested to be executed, i.e., an execution of the EPB control is requested to be stopped when (i) the embodiment control apparatus executes the EPB control, and (ii) the embodiment control apparatus receives the low signal from the EPB switch 77. In this case, the embodiment control apparatus executes the EPB release control to move the mechanically-moved members 26 in the respective braking release directions to decrease the mechanically-moved distances DM to zero, respectively. Thereby, the rear wheel braking forces Br decrease to zero, respectively.

The rear wheel braking forces Br, etc. change as shown in FIG. 5 when the EPB release control is executed. In the example shown in FIG. 5, the EPB switch 77 is positioned at the OFF position at a point of time t55 when the vehicle 100 has stopped. At this moment, the embodiment control apparatus determines that the EPB release control is requested to be executed. Then, the embodiment control apparatus starts the execution of the EPB release control to move the mechanically-moved members 26 in the respective braking release directions. Thereby, the mechanically-moved distances DM decrease. As a result, the rear wheel braking forces Br decrease. Then, the mechanically-moved distances DM decrease to zero, respectively at a point of time t56. As a result, the rear wheel braking forces Br decrease to zero, respectively. At this moment, the embodiment control apparatus terminates the execution of the EPB release control.

### Emergency Braking Control

The embodiment control apparatus determines that the emergency braking control is requested to be executed when (i) the vehicle 100 is moving, and (ii) the embodiment control apparatus receives the high signal from the EPB switch 77. In this case, the embodiment control apparatus executes the emergency braking control. The embodiment control apparatus executes a hydraulically moving process first to move the hydraulically-moved members 24 in the respective braking directions when the embodiment control apparatus starts the execution of the emergency braking control. Thereby, the brake pads 213 are moved in the respective braking directions to be pressed to the respective brake discs 211. Thereby, the braking forces are applied to the wheels 101, respectively. As a result, the movement speed SPD decreases.

Thereafter, the embodiment control apparatus executes a mechanically moving process to move the mechanically-moved members 26 in the respective braking directions at a point of time when a predetermined time Tth elapses since the embodiment control apparatus determines that the emergency braking control is requested to be executed, i.e., (i) the vehicle 100 is moving, and (ii) the EPB switch 77 is positioned at the ON position. The embodiment control apparatus terminates the execution of the mechanically moving process at a point of time when the mechanically-moved distances DM reach the maximum moved distance DMmax, respectively.

The embodiment control apparatus continues executing the hydraulically moving process unless the EPB switch 77 is positioned at the OFF position after the embodiment control apparatus starts the execution of the hydraulically moving process. Therefore, the embodiment control apparatus continues executing the hydraulically moving process unless the EPB switch 77 is positioned at the OFF position after the embodiment control apparatus terminates the execution of the hydraulically moving process unless the EPB switch 77 is positioned at the OFF position after the embodiment control apparatus starts the execution of the mechanically moving process.

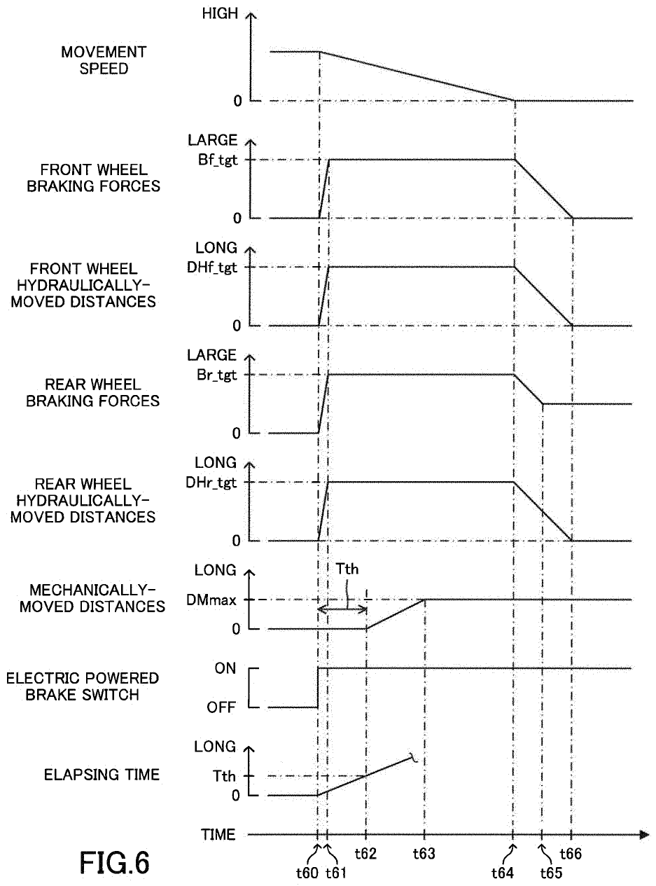

The rear wheel braking forces Br, etc. change, for example, as shown in FIG. 6 when the emergency braking control is executed. FIG. 6 shows changes of the rear wheel braking forces Br, etc. of a case that the driver positions the EPB switch 77 at the ON position since the desired braking forces are not applied to the respective wheels 101, for example, due to problems of the brake pedal 32 although the driver operates the brake pedal 32 to decrease the movement speed SPD.

In an example shown in FIG. 6, the EPB switch 77 is positioned at the ON position at a point of time t60 when the vehicle 100 is moving. At this moment, the embodiment control apparatus determines that the emergency braking control is requested to be executed. Therefore, the embodiment control apparatus starts the execution of the hydraulically moving process to start the execution of the emergency braking control. Thereby, the hydraulically-moved members 24 are moved in the respective braking directions, and the hydraulically-moved distances DH increase. The front wheel brake pads 213F are moved in the respective braking directions and pressed to the respective front wheel brake discs 211F by the respective front wheel hydraulically-moved members 24F when the front wheel hydraulically-moved members 24F are moved in the respective braking directions. As a result, the front wheel braking forces Bf increase. The mechanically-moved distances DM are zero between the point of time t60 and the point of time t62. Therefore, the rear wheel brake pads 213R are moved in the respective braking directions and pressed to the respective rear wheel brake discs 211R by the respective rear wheel hydraulically-moved members 24R when the rear wheel hydraulically-moved members 24R are moved in the respective braking directions. As a result, the rear wheel braking forces Br increase. Thereby, the movement speed SPD decrease.

Thereafter, the hydraulically-moved distances DH reach the target moved distance DHtgt, respectively at the point of time t61. As a result, the braking forces B reaches the target braking force Btgt, respectively. The target braking force Btgt is set to a value capable of decelerating the vehicle 100 at a suitable deceleration when the EPB switch 77 is positioned at the ON position while the vehicle 100 is moving. The target moved distance DHtgt is set to a value capable of achieving the target braking force Btgt.

The embodiment control apparatus maintains the hydraulically-moved distances DH at a constant distance, respectively after the point of time t61. Then, a time elapsing since the EPB switch 77 is positioned at the ON position reaches the predetermined time Tth at the point of time t62. Hereinafter, the time elapsing since the point of time when the EPB switch 77 is positioned at the ON position will be referred to as “the elapsing time Ton”. At this moment, the embodiment control apparatus starts the execution of the mechanically moving process. Thereby, the mechanically-moved members 26 are moved in the respective braking directions. As a result, the mechanically-moved distances DM increase. The mechanically-moved distances DM are shorter than the rear wheel hydraulically-moved distances DHr between the point of time t62 and the point of time t65. Therefore, the rear wheel brake pads 213R are not moved in the respective braking directions by the respective mechanically-moved members 26 even when the mechanically-moved members 26 are moved in the respective braking directions.

Then, the mechanically-moved distances DM reach the maximum moved distance DMmax, respectively at the point of time t63. Then, the movement speed SPD decreases to zero at the point of time t64. Thus, the embodiment control apparatus terminates the execution of the hydraulically moving process at a point of time t64. Thereby, the hydraulic oil is not supplied from the hydraulic actuators 22 to the respective hydraulically-moved members 24. Thus, the hydraulically-moved members 24 move in the respective braking release directions. As a result, the hydraulically-moved distances DH decrease. Then, the rear wheel hydraulically-moved distances DHr become shorter than the respective mechanically-moved distances DM at a point of time t65. Then, the rear wheel hydraulically-moved distances DHr become zero, respectively at a point of time t66. The rear wheel braking forces Br are maintained at the braking forces corresponding to the respective mechanically-moved distances DM after the point of time t65 since the rear wheel hydraulically-moved distances DHr become smaller than the respective mechanically-moved distances DM at the point of time t65. On the other hand, the front wheel hydraulically-moved distances DHf become zero, respectively at a point of time t66. As a result, the front wheel braking forces Bf become zero, respectively.

### Emergency Braking Release Control

The embodiment control apparatus determines that the emergency braking release control is requested to be executed, i.e., the execution of the emergency braking control is requested to be stopped when (i) the embodiment control apparatus executes the emergency braking control, and (ii) the embodiment control apparatus receives the low signal from the EPB switch 77. Then, the embodiment control apparatus stops the execution of the emergency braking control and executes the emergency braking release control to stop applying the braking forces to the wheels 101, respectively.

### Mechanically Releasing Process

The embodiment control apparatus stops the execution of the emergency braking control and starts the execution of the emergency braking release control to execute the mechanically releasing process to move the mechanically-moved members 26 in the respective braking release directions when (i) the embodiment control apparatus determines that the emergency braking release control is requested to be executed, (ii) the hydraulically-moved distances DH are zero, respectively, and (iii) the mechanically-moved distances DM are longer than zero, respectively. The rear wheel brake pads 213R move in the respective braking release directions when the mechanically-moved members 26 move in the respective braking release directions. The rear wheel braking forces Br become zero, respectively when the mechanically-moved members 26 return to the respective base positions Pbase. The embodiment control apparatus terminates the execution of the emergency braking release process to terminate the execution of the emergency braking release control when the mechanically-moved members 26 return to the respective base positions Pbase.

### Hydraulically Releasing Process

The embodiment control apparatus stops the execution of the emergency braking control and starts the execution of the emergency braking release control to execute a hydraulically releasing process to stop supplying the hydraulic oil from the hydraulic actuators 22 to the respective hydraulically-moved members 24 when (i) the embodiment control apparatus determines that the emergency braking release control is requested to be executed, (ii) the hydraulically-moved distances DH are longer than zero, respectively, and (iii) the mechanically-moved distances DM are zero, respectively. Thereby, the hydraulically-moved members 24 and the brake pads 213 move in the respective braking release directions. The braking forces B become zero, respectively when the hydraulically-moved members 24 return to the respective base positions Pbase. The embodiment control apparatus terminates the execution of the hydraulically releasing process to terminate the execution of the emergency braking release control when the hydraulically-moved members 24 return to the respective base positions Pbase.

### Cooperative Braking Release Process

The embodiment control apparatus stops the execution of the emergency braking control and starts the execution of the emergency braking release control to execute a cooperative braking release process when (i) the embodiment control apparatus determines that the emergency braking release control is requested to be executed, (ii) the hydraulically-moved distances DH and the mechanically-moved distances DM are longer than zero, respectively, and (iii) the hydraulically-moved distances DH are longer than the respective mechanically-moved distances DM.

The embodiment control apparatus moves the hydraulically-moved members 24 and the mechanically-moved members 26 first in the respective braking release directions when the embodiment control apparatus starts the execution of the cooperative braking release process. Thereby, the hydraulically-moved distances DH and the mechanically-moved distances DM decrease gradually. The hydraulically-moved distances DH decrease faster than the respective mechanically-moved distances DM. Then, the hydraulically-moved distances DH become equal to the respective mechanically-moved distances DM. The embodiment control apparatus move the hydraulically-moved members 24 and the mechanically-moved members 26 in the respective braking release directions with maintaining the respective hydraulically-moved distances DH and the respective mechanically-moved distances DM equal to each other after the hydraulically-moved distances DH becomes equal to the respective mechanically-moved distances DM. The rear wheel braking forces Br become zero, respectively when the hydraulically-moved members 24 and the mechanically-moved members 26 return to the respective base positions Pbase. The embodiment control apparatus terminates the execution of the cooperative braking release process to terminate the execution of the emergency braking release control when the hydraulically-moved members 24 and the mechanically-moved members 26 return to the respective base positions Pbase.

The embodiment control apparatus stops the execution of the emergency braking control and starts the execution of the emergency braking release control to execute a cooperative braking release process when (i) the embodiment control apparatus determines that the emergency braking release control is requested to be executed, (ii) the hydraulically-moved distances DH and the mechanically-moved distances DM are longer than zero, respectively, and (iii) the hydraulically-moved distances DH are shorter than the respective mechanically-moved distances DM.

The embodiment control apparatus moves the mechanically-moved members 26 first in the respective braking release directions without moving the hydraulically-moved members 24 when the embodiment control apparatus starts the execution of the cooperative braking release process. Thereby, the mechanically-moved distances DM decrease gradually. Then, the mechanically-moved distances DM become equal to the respective hydraulically-moved distances DH. The embodiment control apparatus move the hydraulically-moved members 24 and the mechanically-moved members 26 in the respective braking release directions with maintaining the respective hydraulically-moved distances DH and the respective mechanically-moved distances DM equal to each other after the mechanically-moved distances DM becomes equal to the respective hydraulically-moved distances DH. The rear wheel braking forces Br becomes zero, respectively when the hydraulically-moved members 24 and the mechanically-moved members 26 return to the respective base positions Pbase. The embodiment control apparatus terminates the execution of the cooperative braking release process to terminate the execution of the emergency braking release control when the hydraulically-moved members 24 and the mechanically-moved members 26 return to the respective base positions Pbase.

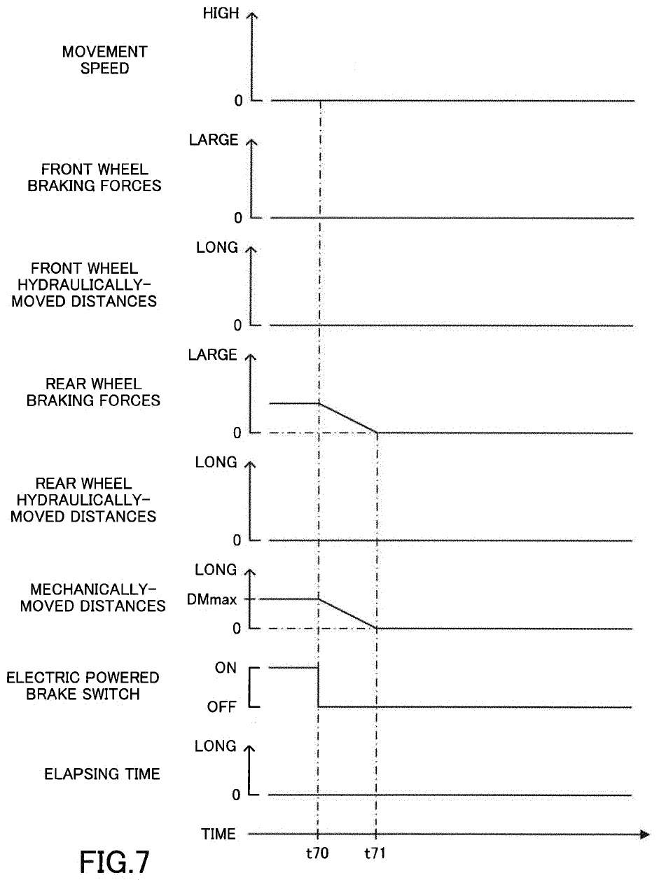

The rear wheel braking forces Br, etc. change, for example, as shown in FIG. 7 when the emergency braking release control is executed. In an example shown in FIG. 7, the EPB switch 77 is positioned at the OFF position at a point of time t70 when the emergency braking control is executed. At this moment, the embodiment control apparatus determines that the emergency braking release control is requested to be executed. Then, the embodiment control apparatus stops the execution of the emergency braking control and starts the execution of the emergency braking release control to execute the mechanically releasing process. Thereby, the mechanically-moved distances DM decrease. As a result, the rear wheel braking forces Br decrease. It should be noted that the hydraulically-moved distances DH are zero, respectively at the point of time t70.

Thereafter, the mechanically-moved distances DM become zero, respectively at a point of time t71. As a result, the rear wheel braking forces Br become zero, respectively. At this moment, the embodiment control apparatus terminates the execution of the mechanically releasing process to terminate the execution of the emergency braking release control.

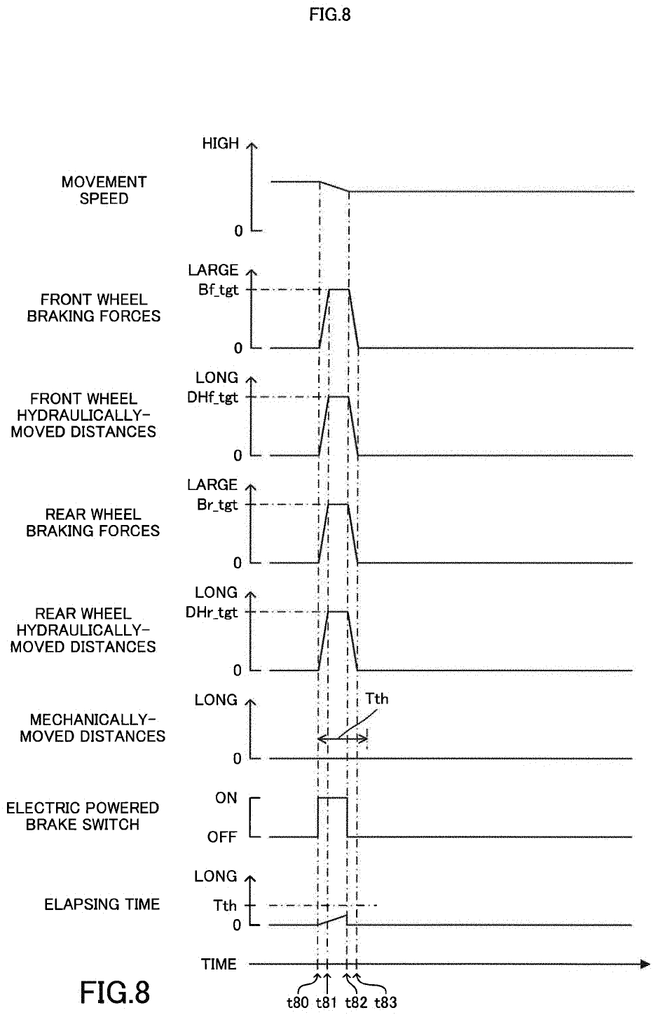

With the embodiment control apparatus, the rear wheel braking forces Br, etc. change, for example, as shown in FIG. 8 when the driver mistakenly positions the EPB switch 77 at the ON position and then, positions the EPB switch 77 at the OFF position before the predetermined time Tth elapses.

In an example shown in FIG. 8, the EPB switch 77 is positioned at the ON position at a point of time t80. At this moment, the embodiment control apparatus determines that the emergency braking control is requested to be executed. In this case, the embodiment control apparatus starts the execution of the emergency braking control to execute the hydraulically moving process. Thereby, the hydraulically-moved members 24 move in the respective braking directions. As a result, the hydraulically-moved distances DH increase. The mechanically-moved distances DM are zero, respectively at the point of time t80. Therefore, the rear wheel brake pads 213R are moved by the respective rear wheel hydraulically-moved members 24R in the respective braking directions to be pressed to the respective rear wheel brake discs 211R when the rear wheel hydraulically-moved members 24R move in the respective braking directions. As a result, the rear wheel braking forces Br increase. The front wheel brake pads 213F are moved by the respective front wheel hydraulically-moved members 24F to be pressed to the respective front wheel brake discs 211F in the respective braking directions when the front wheel hydraulically-moved members 24F move in the respective braking directions. As a result, the front wheel braking forces Bf increase. Thereby, the movement speed SPD decreases.

Thereafter, the hydraulically-moved distances DH reach the target moved distance DHtgt, respectively at a point of time t81. As a result, the braking forces B reach the target braking force Btgt, respectively. The embodiment control apparatus maintains the hydraulically-moved distances DH at a constant distance, respectively after the point of time t81.

Thereafter, the embodiment control apparatus determines that the emergency braking release control is requested to be executed at a point of time t82 when (i) the embodiment control apparatus executes the emergency braking control, and (ii) the EPB switch 77 is positioned at the OFF position. At this moment, the mechanically-moved distances DM are zero, respectively. Thus, the embodiment control apparatus stops the execution of the emergency braking control and starts the execution of the emergency braking release control to execute the hydraulically releasing process. Thereby, the hydraulic oil is not supplied from the hydraulic actuators 22 to the respective hydraulically-moved members 24. Thus, the hydraulically-moved members 24 move in the respective braking release directions. Thus, the hydraulically-moved distances DH decrease. As a result, the braking forces B decrease.

Thereafter, the hydraulically-moved distances DH become zero, respectively at a point of time t83. As a result, the braking forces B become zero, respectively. At this moment, the embodiment control apparatus terminates the execution of the emergency braking release control.

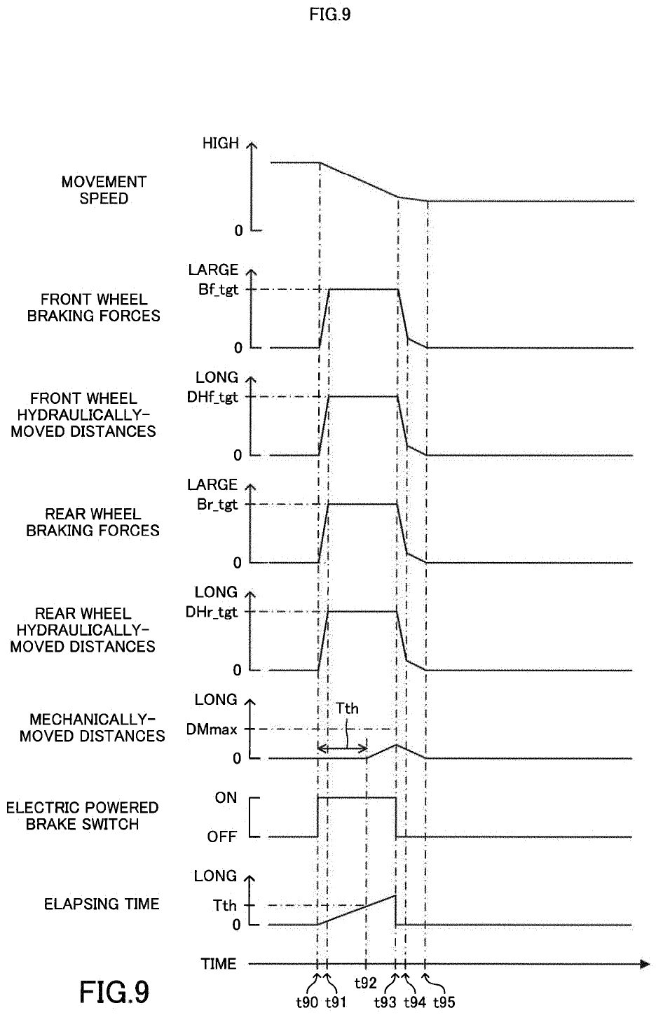

With the embodiment control apparatus, the rear wheel braking forces Br, etc. change, for example, as shown in FIG. 9 when the driver mistakenly positions the EPB switch 77 at the ON position and then, positions the EPB switch 77 at the OFF position before the mechanically-moved distances DM reach the maximum moved distance DMmax, respectively after the predetermined time Tth elapses.

In an example shown in FIG. 9, the EPB switch 77 is positioned at the ON position at a point of time t90 when the vehicle 100 is moving. At this moment, the embodiment control apparatus determines that the emergency braking control is requested to be executed. In this case, the embodiment control apparatus starts the execution of the emergency braking control to execute the hydraulically moving process. Thereby, the hydraulically-moved members 24 move in the respective braking directions. As a result, the hydraulically-moved distances DH increase. The mechanically-moved distances DM are zero, respectively at the point of time t90. Therefore, the rear wheel brake pads 213R are moved by the respective rear wheel hydraulically-moved members 24R in the respective braking directions to be pressed to the respective rear wheel brake discs 211R in the respective braking directions when the rear wheel hydraulically-moved members 24R move in the respective braking directions. As a result, the rear wheel braking forces Br increase. The front wheel brake pads 213F are moved by the respective front wheel hydraulically-moved members 24F in the respective braking directions to be pressed to the respective front wheel brake discs 211F when the front wheel hydraulically-moved members 24F move in the respective braking directions. As a result, the front wheel braking forces Bf increase. Thereby, the movement speed SPD decreases.

Thereafter, the hydraulically-moved distances DH reach the target moved-distance DHtgt, respectively at a point of time t91. As a result, the braking forces reach the target braking force Btgt, respectively. The embodiment control apparatus maintains the hydraulically-moved distances DH at the constant distance, respectively after the point of time t91.

Thereafter, the elapsing time Ton reaches the predetermined time Tth at a point of time t92. At this moment, the embodiment control apparatus starts the execution of the mechanically moving process. Thereby, the mechanically-moved members 26 move in the respective braking directions. As a result, the mechanically-moved distances DM increase. The mechanically-moved distances DM are shorter than the respective hydraulically-moved distances DHr at the point of time t92. Thus, the rear wheel brake pads 213R are not moved by the respective mechanically-moved members 26 in the respective braking directions even when the mechanically-moved members 26 move in the respective braking directions.

Thereafter, the embodiment control apparatus determines that the emergency braking release control is requested to be executed when the EPB switch 77 is positioned at the OFF position at a point of time t93. At this moment, the mechanically-moved distances DM are longer than zero, respectively. Thus, the embodiment control apparatus stops the execution of the emergency braking control and starts the execution of the emergency braking release control to execute the cooperative braking release process. At this moment, the rear wheel hydraulically-moved distances DHr are longer than the respective mechanically-moved distances DM. Thus, the embodiment control apparatus moves the hydraulically-moved members 24 and the mechanically-moved members 26 in the respective braking release directions. Thereby, the hydraulically-moved distances DH and the mechanically-moved distances DM decrease gradually.

Thereafter, the rear wheel hydraulically-moved distances DHr become equal to the respective mechanically-moved distances DM at a point of time t94. Therefore, the embodiment control apparatus decreases the hydraulically-moved distances DH and the mechanically-moved distances DM with maintaining the respective hydraulically-moved distances DH and the respective mechanically-moved distances DM equal to each other after the point of time t94. Thereafter, the hydraulically-moved distances DH and the mechanically-moved distances DM become zero, respectively at the point of time t95. At a result, the braking forces become zero, respectively. At this moment, the embodiment control apparatus terminates the execution of the emergency braking release control.

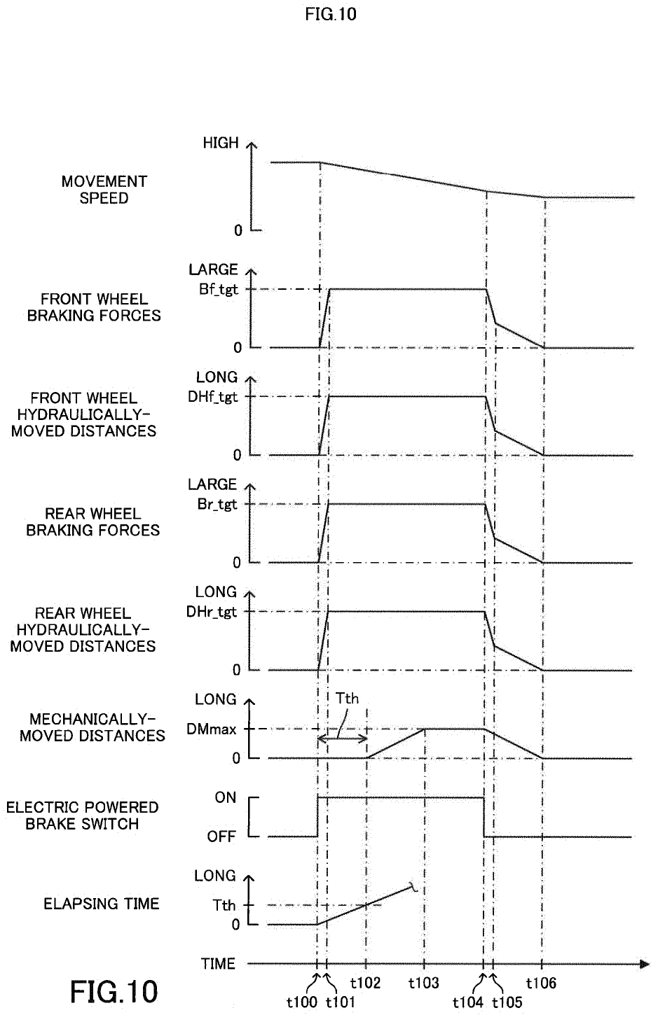

With the embodiment control apparatus, the rear wheel braking forces Br, etc. change, for example, as shown in FIG. 10 when the driver mistakenly positions the EPB switch 77 at the ON position and then, positions the EPB switch 77 at the OFF position after the predetermined time Tth elapses, and the mechanically-moved distances DM reach the maximum moved distance DMmax, respectively.

In an example shown in FIG. 10, the EPB switch 77 is positioned at the ON position at a point of time t100 when the vehicle 100 is moving. At this moment, the embodiment control apparatus determines that the emergency braking control is requested to be executed. In this case, the embodiment control apparatus starts the execution of the emergency braking control to execute the hydraulically moving process. Thereby, the hydraulically-moved members 24 move in the respective braking directions. As a result, the hydraulically-moved distances DH increase. The mechanically-moved distances DM are zero, respectively at the point of time t100. Therefore, the rear wheel brake pads 213R are moved by the respective rear wheel hydraulically-moved members 24R in the respective braking directions to be pressed to the respective rear wheel brake discs 211R when the rear wheel hydraulically-moved members 24R move in the respective braking directions. As a result, the rear wheel braking forces Br increase. The front wheel brake pads 213F are moved by the respective front wheel hydraulically-moved members 24F in the respective braking directions to be pressed to the respective front wheel brake discs 211F when the front wheel hydraulically-moved members 24F move in the respective braking directions. As a result, the front wheel braking forces Bf increase. Thereby, the movement speed SPD decreases.

Thereafter, the hydraulically-moved distances DH reach the target moved distance DHtgt, respectively at a point of time t101. As a result, the braking forces B reach the target braking force Btgt, respectively. The embodiment control apparatus maintains the hydraulically-moved distances DH at the constant distance, respectively after the point of time t101.

Thereafter, the elapsing time Ton reaches the predetermined time Tth at a point of time t102. At this moment, the embodiment control apparatus starts the execution of the mechanically moving process. Thereby, the mechanically-moved members 26 move in the respective braking directions. As a result, the mechanically-moved distances DM increase. The mechanically-moved distances DM are shorter than the respective hydraulically-moved distances DHr at the point of time t102. Therefore, the rear wheel brake pads 213R are not moved by the respective mechanically-moved members 26 in the respective braking directions even when the mechanically-moved members 26 move in the respective braking directions.

Thereafter, the mechanically-moved distances DM become the maximum moved distance DMmax, respectively at a point of time t103. Thereafter, the embodiment control apparatus determines that the emergency braking release control is requested to be executed when the EPB switch 77 is positioned at the OFF position at a point of time t104. At this moment, the mechanically-moved distances DM are longer than zero, respectively. Therefore, the embodiment control apparatus stops the execution of the emergency braking control and starts the execution of the emergency braking release control to execute the cooperative braking releasing process. At this moment, the rear wheel hydraulically-moved distances DHr are longer than the respective mechanically-moved distances DM. Therefore, the embodiment control apparatus moves the hydraulically-moved members 24 and the mechanically-moved members 26 in the respective braking release directions. Thereby, the hydraulically-moved distances DH and the mechanically-moved distances DM decrease gradually.

Thereafter, the rear wheel hydraulically-moved distances DHr become equal to the respective mechanically-moved distances DM at a point of time t105. Therefore, the embodiment control apparatus decreases the hydraulically-moved distances DH and the mechanically-moved distances DM with maintaining the respective hydraulically-moved distances DH and the respective mechanically-moved distances DM equal to each other after the point of time t105. Thereafter, the hydraulically-moved distances DH and the mechanically-moved distances DM become zero, respectively at a point of time t106. As a result, the braking forces B become zero, respectively. At this moment, the embodiment control apparatus terminates the execution of the emergency braking release control.

With the emergency braking control according to the embodiment, the mechanically-moved members 26 do not start to move in the respective braking directions until the predetermined time Tth elapses even when the EPB switch 77 is positioned at the ON position while the vehicle 100 is moving. Thus, the mechanically-moved members 26 may not start to move in the respective braking directions at a point of time when the driver positions the EPB switch 77 at the OFF position just after the driver positions the EPB switch 77 at the ON position while the vehicle 100 is moving. Alternatively, the mechanically-moved distances DM may be short even when the mechanically-moved members 26 have started to move in the respective braking directions.

A situation that three or less of the wheels 101 are still subject to the braking forces does not occur even by decreasing the hydraulic pressures applied to the hydraulically-moved members 24 to zero at once when the mechanically-moved members 26 have not been moved in the respective braking directions at the point of time when the execution of the emergency braking control is requested to be stopped. Therefore, the vehicle 100 may move with stability. In addition, the braking forces applied to the respective wheels 101 can be promptly decreased to zero, respectively when the execution of the emergency braking control is requested to be stopped.

The mechanically-moved distances DM can be decreased to zero for a short time, respectively when the mechanically-moved distances DM are short at a point of time when the execution of the emergency braking control is requested to be stopped. Therefore, with the emergency braking control according to the embodiment, the braking forces applied to the respective wheels 101 can be decreased to zero for a short time, respectively when the execution of the emergency braking control is requested to be stopped.

Further, with the emergency braking release control according to the embodiment, the respective front wheel braking forces Bf and the respective rear wheel braking forces Br are decreased to zero with being maintained equal to each other. Therefore, the situation that three or less of the wheels 101 are still subject to the braking forces may not occur. Thus, the vehicle 100 may move with stability.

### Specific Operation of Embodiment Control Apparatus

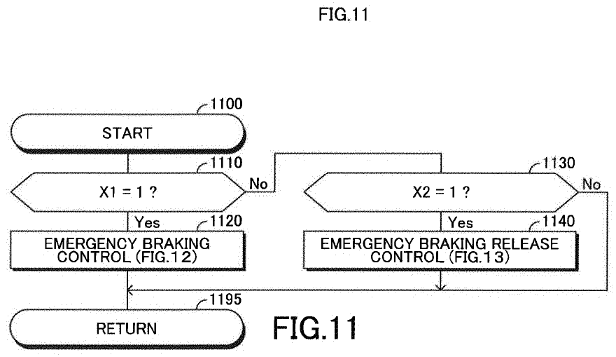

Next, a specific operation of the embodiment control apparatus will be described. The CPU of the ECU 90 of the embodiment control apparatus is configured or programmed to execute a routine shown in FIG. 11 each time a predetermined time elapses. Therefore, at a predetermined timing, the CPU starts a process from a step 1100 and then, proceeds with the process to a step 1110 to determine whether a value of an emergency braking request flag X1 is “1”. The value of the emergency braking request X1 is set to “1” when the EPB switch 77 is positioned at the ON position while the vehicle 100 is moving. On the other hand, the value of the emergency braking request X1 is set to “0” when the EPB switch 77 is positioned at the OFF position.

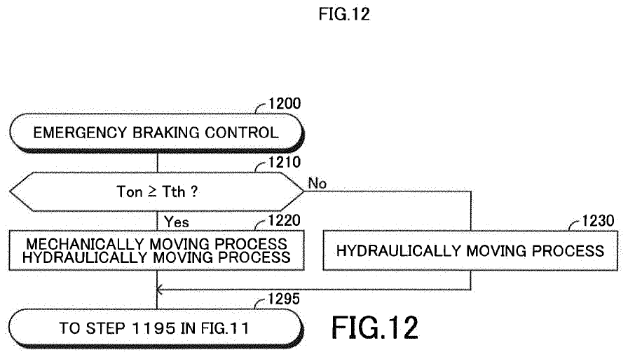

When the CPU determines “Yes” at the step 1110, the CPU proceeds with the process to a step 1120 to execute a routine shown in FIG. 12. When the CPU executes the routine shown in FIG. 12, the CPU starts a process from a step 1200 and then, proceeds with the process to a step 1210 to determine whether the elapsing time Ton elapsing since the EPB switch 77 is positioned at the ON position is equal to or longer than the predetermined time Tth.

When the CPU determines “No” at the step 1210, the CPU proceeds with the process to a step 1230 to execute the hydraulically moving process. In other words, the CPU continues executing the hydraulically moving process until the elapsing time Ton reaches the predetermined time Tth. Thereafter, the CPU proceeds with the process to a step 1195 in FIG. 11 via a step 1295 to terminate this routine once.

On the other hand, when the CPU determines “Yes” at the step 1210, the CPU executes the hydraulically moving process and the mechanically moving process. In other words, the CPU executes the hydraulically moving process and the mechanically moving process after the elapsing time Ton exceeds the predetermined time Tth. Thereafter, the CPU proceeds with the process to the step 1195 in FIG. 11 via the step 1295 to terminate this routine once.

When the CPU determines “No” at the step 1110 in FIG. 11, the CPU proceeds with the process to a step 1130 to determine whether a value of an emergency braking release request flag X2 is “1”. The value of the emergency braking release flag X2 is set to “1” when the emergency braking release control is requested to be executed. On the other hand, the value of the emergency braking release flag X2 is set to “0” when the hydraulically-moved distances DH and the mechanically-moved distances DM become zero, respectively after the emergency braking release control is requested to be executed.

When the CPU determines “No” at the step 1130, the CPU proceeds with the process to the step 1195 to terminate this routine once.

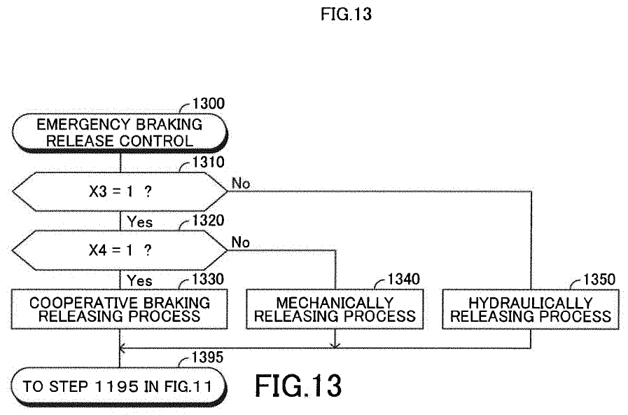

On the other hand, when the CPU determines “Yes” at the step 1130, the CPU proceeds with the process to a step 1140 to execute a routine shown in FIG. 13. When the CPU executes the routine shown in FIG. 13, the CPU starts a process from a step 1300 and then, proceeds with the process to a step 1310 to determine whether a value of a mechanically moving flag X3 is “1”. The value of the mechanically moving flag X3 is set to “1” when the mechanically-moved distances DM are longer than zero, respectively. On the other hand, the value of the mechanically moving flag X3 is set to “0” when the mechanically-moved distances DM are zero, respectively.

When the CPU determines “Yes” at the step 1310, the CPU proceeds with the process to a step 1320 to determine whether a value of a hydraulic moving flag X4 is “1”. The value of the hydraulically moving flag X4 is set to “1” when the hydraulically-moved distances DH are longer than zero, respectively. On the other hand, the value of the hydraulically moving flag X4 is set to “0” when the hydraulically-moved distances DH are zero, respectively.

When the CPU determines “Yes” at the step 1320, the CPU proceeds with the process to a step 1330 to execute the cooperative braking release process. Thereafter, the CPU proceeds with the process to the step 1195 in FIG. 11 via a step 1395 to terminate this routine once.

On the other hand, when the CPU determines “No” at the step 1320, the CPU proceeds with the process to a step 1340 to execute the mechanically releasing process. Thereafter, the CPU proceeds with the process to the step 1195 in FIG. 11 via the step 1395 to terminate this routine once.

When the CPU determines “No” at the step 1310, the CPU proceeds with the process to a step 1350 to execute the hydraulically releasing process. Thereafter, the CPU proceeds with the process to the step 1195 in FIG. 11 via the step 1395 to terminate this routine once.

It should be noted that the present disclosure is not limited to the aforementioned embodiment and various modifications can be employed within the scope of the present disclosure.

For example, the embodiment control apparatus may be configured to determine that the emergency braking release control is requested to be executed when the acceleration pedal 31 is operated after the EPB switch 77 is positioned at the ON position while the vehicle 100 is moving. Further, the embodiment control apparatus may be configured to determine that the EPB release control is requested to be executed when the acceleration pedal 31 is operated after the EPB switch 77 is positioned at the ON position while the vehicle 100 is moving.

Further, the embodiment control apparatus may be configured to execute the cooperative braking release process to move the hydraulically-moved members 24 and the mechanically-moved members 26 in the respective braking release directions with maintaining the hydraulically-moved distances DH longer than the respective mechanically-moved distances DM when (i) the hydraulically-moved distances DH and the mechanically-moved distances DM are longer than zero, respectively, and (ii) the hydraulically-moved distances DH are longer than the respective mechanically-moved distances DM. In this case, the embodiment control apparatus may be configured to move the hydraulically-moved members 24 and the mechanically-moved members 26 in the respective braking release directions so as to decrease the hydraulically-moved distances DH and the mechanically-moved distances DM to zero, respectively at the same time. Alternatively, the embodiment control apparatus may be configured to move the hydraulically-moved members 24 and the mechanically-moved members 26 in the respective braking release directions such that the hydraulically-moved distances DH become zero, respectively after the mechanically-moved distances DM become zero, respectively.

Further, the embodiment control apparatus may be configured to execute the cooperative braking releasing process to move the hydraulically-moved members 24 and the mechanically-moved members 26 in the respective braking release directions with maintaining the mechanically-moved distances DM longer than the respective hydraulically-moved distances DH when (i) the hydraulically-moved distances DH and the mechanically-moved distances DM are longer than zero, respectively, and (ii) the hydraulically-moved distances DH are smaller than the respective mechanically-moved distances DM. In this case, the embodiment control apparatus may be configured to move the hydraulically-moved members 24 and the mechanically-moved members 26 in the respective braking release directions such that the hydraulically-moved distances DH and the mechanically-moved distances DM become zero at the same time. Alternatively, the embodiment control apparatus may be configured to move the hydraulically-moved members 24 and the mechanically-moved members 26 in the respective braking release directions such that the mechanically-moved distances DM become zero, respectively after the hydraulically-moved distances DH become zero, respectively.

What is claimed is:

1. A vehicle braking control apparatus applied to a vehicle, comprising:
at least one brake apparatus including:
at least one brake pad;
at least one brake disc;
at least one hydraulically-moved member configured to be moved by hydraulic pressure in a direction toward the at least one brake disc and in a direction away from the at least one brake disc; and
at least mechanically-moved member configured to be moved by an electric motor in the direction toward the at least one brake disc and in the direction away from the at least one brake disc; and
an electronic control unit configured to control an activation of the at least one brake apparatus,
the at least one brake pad being configured to be moved toward the at least one brake disc to be pressed to the at least one brake disc to apply a braking force to at least one wheel of the vehicle by moving the at least one hydraulically-moved member toward the at least one brake disc,
the at least one brake pad being configured to be moved toward the at least one brake disc to be pressed to the at least one brake disc to apply the braking force to the at least one wheel of the vehicle by moving the at least one mechanically-moved member toward the at least one brake disc,
wherein the electronic control unit is configured to:
start an execution of a hydraulically moving process to move the at least one hydraulically-moved member toward the at least one brake disc when an emergency braking control is requested to be executed to move the at least one hydraulically-moved member and the at least one mechanically-moved member toward the at least one brake disc to apply the braking force to the at least one wheel of the vehicle;
start an execution of a mechanically moving process to move the at least one mechanically-moved member toward the at least one brake disc when a predetermined time elapses since the electronic control unit starts the execution of the hydraulically moving process; and
stop the execution of the hydraulically moving process and the execution of the mechanically moving process and execute (i) a hydraulically releasing process to move the at least one hydraulically-moved member away from the at least one brake disc and (ii) a mechanically releasing process to move the at least one mechanically-moved member away from the at least one brake disc when an execution of the emergency braking control is requested to be stopped.

2. The vehicle braking control apparatus as set forth in claim 1, wherein the electronic control unit is configured to execute the hydraulically releasing process and the mechanically releasing process such that a hydraulic braking force is maintained greater than or equal to a mechanical braking force, the hydraulic braking force being the braking force applied to the at least one wheel of the vehicle by pressing the at least one brake pad to the at least one brake disc by the at least one hydraulically-moved member, the mechanical braking force being the braking force applied to the at least one wheel of the vehicle by pressing the at least one brake pad to the at least one brake disc by the at least one mechanically-moved member.

3. The vehicle braking control apparatus as set forth in claim 1, wherein
the at least one wheel of the vehicle includes at least two wheels,
the at least one hydraulically-moved member includes the same number of hydraulically-moved members as the number of the at least two wheels,
the at least one mechanically-moved member includes the number of mechanically-moved members smaller than the number of the at least two wheels,
the hydraulically-moved members are provided to the at least two wheels, respectively, and
the mechanically-moved members are provided to a part of the at least two wheels, respectively.

4. The vehicle braking control apparatus as set forth in claim 1, wherein the at least one hydraulically-moved member is configured to apply a hydraulic braking force greater than a maximum mechanical braking force to the at least one wheel of the vehicle, the hydraulic braking force being generated by pressing the at least one brake pad to the at least one brake disc by the at least one hydraulically-moved member, the maximum mechanical braking force being maximumly generated by pressing the at least one brake pad to the at least one brake disc by the at least one mechanically-moved member.

5. A vehicle braking control apparatus applied to a vehicle, comprising:
at least one brake apparatus including:
at least one brake pad;
at least one brake disc;
at least one hydraulically-moved member configured to be moved by hydraulic pressure in a direction toward the at least one brake disc and in a direction away from the at least one brake disc; and
at least mechanically-moved member configured to be moved by an electric motor in the direction toward the at least one brake disc and in the direction away from the at least one brake disc; and
an electronic control unit configured to control an activation of the at least one brake apparatus,
the at least one brake pad being configured to be moved toward the at least one brake disc to be pressed to the at least one brake disc to apply a braking force to at least one wheel of the vehicle by moving the at least one hydraulically-moved member toward the at least one brake disc,
the at least one brake pad being configured to be moved toward the at least one brake disc to be pressed to the at least one brake disc to apply the braking force to the at least one wheel of the vehicle by moving the at least one mechanically-moved member toward the at least one brake disc,
wherein the electronic control unit is configured to:
execute a hydraulically moving process and a mechanically moving process when an emergency braking control is requested to be executed to move the at least one hydraulically-moved member and the at least one mechanically-moved member toward the at least one brake disc to apply the braking force to the at least one wheel of the vehicle, the hydraulically moving process being a process to move the at least one hydraulically-moved member toward the at least one brake disc, the mechanically moving process being a process to move the at least one mechanically-moved member toward the at least one brake disc; and
stop an execution of the hydraulically moving process and an execution of the mechanically moving process and execute (i) a hydraulically releasing process to move the at least one hydraulically-moved member away from the at least one brake disc and (ii) a mechanically releasing process to move the at least one mechanically-moved member away from the at least one brake disc such that a hydraulic braking force is maintained greater or equal to a mechanical braking force, the hydraulic braking force being the braking force applied to the at least one wheel of the vehicle by pressing the at least one brake pad to the at least one brake disc by the at least one hydraulically-moved member, the mechanical braking force being the braking force applied to the at least one wheel of the vehicle by pressing the at least one brake pad to the at least one brake disc by the at least one mechanically-moved member.

6. The vehicle braking control apparatus as set forth in claim 5, wherein
the at least one wheel of the vehicle includes at least two wheels,
the at least one hydraulically-moved member includes the same number of hydraulically-moved members as the number of the at least two wheels,
the at least one mechanically-moved member includes the number of mechanically-moved members smaller than the number of the at least two wheels,
the hydraulically-moved members are provided to the at least two wheels, respectively, and
the mechanically-moved members are provided to a part of the at least two wheels, respectively.

7. The vehicle braking control apparatus as set forth in claim 5, wherein the at least one hydraulically-moved member is configured to apply a hydraulic braking force greater than a maximum mechanical braking force to the at least one wheel of the vehicle, the hydraulic braking force being generated by pressing the at least one brake pad to the at least one brake disc by the at least one hydraulically-moved member, the maximum mechanical braking force being maximumly generated by pressing the at least one brake pad to the at least one brake disc by the at least one mechanically-moved member.
